(19) United States
(12) Patent Application Publication
(10) Pub. No.: US 2012/0094686 A1
(43) Pub. Date: Apr. 19, 2012

(54) COMMUNICATION SYSTEM, INFORMATION ANALYZING APPARATUS, AND INFORMATION ANALYZING METHOD

(75) Inventors: Toshihiro Suzuki, Kanagawa (JP); Ichiro Okajima, Kanagawa (JP); Hiroshi Kawakami, Kanagawa (JP); Manhee Jo, Kanagawa (JP); Daisuke Ochi, Kanagawa (JP); Tomohiro Nagata, Tokyo (JP); Motonari Kobayashi, Kanagawa (JP); Yuki Oyabu, Kanagawa (JP)

(73) Assignee: NTT DOCOMO, INC., Chiyoda-ku, TOKYO (JP)

(21) Appl. No.: 13/257,724

(22) PCT Filed: Mar. 29, 2010
(86) PCT No.: PCT/JP2010/055554

§ 371 Date: Dec. 5, 2011

(30) Foreign Application Priority Data
Apr. 6, 2009 (JP) 2009-092224

(51) Int. Cl. H04W 24/00

(52) U.S. Cl. 455/456.1

(57) ABSTRACT

For easily and quickly collecting data regarding macroscopic population fluidity, and easily and quickly obtaining the survey results, an RNC includes: a positioning module that measures the position of a mobile station; and an RNC communication controller that transmits location information of the mobile station that the positioning module measures, identification information of the mobile station, and time information when the positioning module measures the position of the mobile station, to an information analyzing apparatus, and the information analyzing apparatus includes: a location extractor that extracts movement information indicating a moving situation of the mobile station at a given time and including information corresponding to at least the location information based on the location information, the identification information and the time information; and an output module that calculates total movement information by integrating the movement information and outputs the total movement information thus calculated.

### TECHNICAL FIELD

The present invention relates to an information analyzing apparatus and an information analyzing method for estimating data regarding population fluidity and a communication system that is configured to include the information analyzing apparatus.

### BACKGROUND ART

Conventionally, as a method of collecting data regarding macroscopic population fluidity, there are a census that is conducted nationwide on a 5-year cycle and a person trip survey for investigating movement history of those surveyed. These census and person trip survey require a series of very laborious activities such as distributing questionnaires to those surveyed, collecting them, and tallying them with many workers, whereby it takes time to obtain the survey results. In addition, on householders or the like who respond, these surveys impose burdens such as filling out and sending the questionnaires.

### CITATION LIST

### Patent Literature

[Patent Literature 1] Japanese Patent Application Laid-Open Publication No. 2005-202546

### SUMMARY OF INVENTION

### Technical Problem

As described above, conventionally, even only collecting data regarding macroscopic population fluidity is very troublesome, and thus it is difficult to collect the data easily and quickly and obtain the survey results.

On the other hand, a technique for estimating amount of movement of people based on the number of passengers who get on and off at stations is disclosed in Patent Literature 1. However, even this technique requires a processing load and time to obtain the number of passengers who get on and off at stations that is basic data for the estimation. Accordingly, a technique of easily and quickly collecting data regarding population fluidity and investigating them has been expected.

The present invention, considering the above-mentioned problem, is aimed at easily and quickly collecting data regarding macroscopic population fluidity, and easily and quickly obtaining the survey results.

### Solution to Problem

To solve the above-mentioned problem, a communication system according to one aspect of the present invention is configured to include: a mobile station that is located in a sector that a base transceiver station controls; a radio network controller that controls the base transceiver station; and an information analyzing apparatus that is communicably connected with the radio network controller, and the radio network controller includes: a positioning module that measures a position of the mobile station; and a transmitter that transmits location information as information regarding the position of the mobile station that the positioning module measures, identification information as an identifier that makes the mobile station uniquely identifiable, and time information as information regarding a time when the positioning module measures the position of the mobile station, to the information analyzing apparatus, and the information analyzing apparatus includes: a location extractor that extracts movement information indicating a moving situation of the mobile station at a given time and including information corresponding to at least the location information based on the location information, the identification information and the time information; and an output module that calculates total movement information by integrating the movement information and outputs the total movement information thus calculated.

With this structure, it is possible to easily and quickly obtain survey results data regarding macroscopic population fluidity, by easily and quickly collecting location information of a mobile station and time information when its position is measured and outputting total movement information into which movement information of the mobile station is integrated based on the location information and time information.

The positioning module may measure the position of the mobile station using, as a trigger event, at least any one of: when the mobile station transmits; when the mobile station receives a transmission; when the mobile station moves across a boundary of location registration areas which are areas formed by the base transceiver station and are unit areas in which the mobile station registers its own position with the radio network controller; and when a given timing in a given period arrives.

By measuring a position, when the mobile station transmits, the mobile station receives a transmission, and when the mobile station moves across a boundary of location registration areas which are areas formed by the base transceiver station and are unit areas in which the mobile station registers its own position with the radio network controller, it is possible to measure a position while suppressing additional load to various types of communication equipment.

By measuring a position, when a given timing in a given period arrives, it is possible to measure a position at least once in the given period without exception.

In addition, the information analyzing apparatus may further include an association module that converts an expression form of the movement information extracted by the location extractor into an expression form for giving expression as a movement from one area unit to another area unit in association with an area unit having a certain range of spread.

By setting the area unit to a desired unit (for example, an area 100 meters square, an area 10 kilometers square, or an administrative district such as a municipality), it is possible to output total movement information with accuracy responding to requests.

In addition, the information analyzing apparatus may further include: an attribute information storage module that stores attribute information representing attributes of a user using the communication system in association with the identification information therein; and an attribute determination module that determines whether or not to use the movement information so as to integrate the movement information and output the total movement information thus integrated, based on the attribute information stored by the attribute information storage module.

With this structure, it is possible to output total movement information by desired attributes.

In addition, the given time regarding the movement information may have a time range, and the time range may be optionally settable. In this case, the location extractor, with respect to the movement information at the given time having the time range, may extract movement information for each of a plurality of time zones that are obtained by dividing the time range in plurality, and the output module may integrate the movement information for each of the plurality of time zones to calculate total movement information for each time zone, and integrate the total movement information for each time zone to calculate total movement information at the given time having the time range. In addition, the output module may output the total movement information at the given time having the time range.

In such a case, it is possible to obtain the total movement information at the given time having the time range, and accordingly, it is possible to obtain total movement information regarding a movement, for example, from one area unit to another area unit that is not adjacent to the one area unit.

To solve the above-mentioned problem, an information analyzing apparatus according to another aspect of the present invention is communicably connected with a radio network controller that controls a base transceiver station controlling a sector in which a mobile station is located, and the information analyzing apparatus includes: a receiver that receives location information as information regarding a position of the mobile station that the radio network controller measures, identification information as an identifier that makes the mobile station uniquely identifiable, and time information as information regarding a time when the radio network controller measures the position of the mobile station; a location extractor that extracts movement information indicating a moving situation of the mobile station at a given time and including information at least corresponding to the location information based on the location information, the identification information and the time information that the receiver receives; and an output module that calculates total movement information by integrating the movement information and outputs the total movement information thus calculated.

With this structure, it is possible to easily and quickly obtain survey results data regarding macroscopic population fluidity, by easily and quickly collecting location information of a mobile station and time information when its position is measured and outputting total movement information into which movement information of the mobile station is integrated based on the location information and time information.

To solve the above-mentioned problem, an information analyzing method according to another aspect of the present invention is executed in a communication system configured to include: a mobile station that is located in a sector that a base transceiver station controls; a radio network controller that controls the base transceiver station; and an information analyzing apparatus that is communicably connected with the radio network controller, and the information analyzing method includes: a positioning step in which the radio network controller measures the position of the mobile station; a transmitting step in which the radio network controller transmits location information as information regarding the position of the mobile station that is measured at the positioning step, identification information as an identifier that makes the mobile station uniquely identifiable, and time information as information regarding a time when the position of the mobile station is measured at the positioning step, to the information analyzing apparatus; a location extracting step in which the information analyzing apparatus extracts movement information indicating a moving situation of the mobile station at a given time and including information at least corresponding to the location information based on the location information, the identification information and the time information; and an outputting step in which the information analyzing apparatus calculates total movement information by integrating the movement information and outputs the total movement information thus calculated.

With this structure, it is possible to easily and quickly obtain survey results data regarding macroscopic population fluidity, by easily and quickly collecting location information of a mobile station and time information when its position is measured and outputting total movement information into which movement information of the mobile station is integrated based on the location information and time information.

### Advantageous Effects of Invention

According to the present invention, it is possible to easily and quickly (in almost real time) collect data regarding macroscopic population fluidity, and to easily and quickly obtain survey results.

### BRIEF DESCRIPTION OF DRAWINGS

FIG. 1 is a diagram illustrating a system structure of a communication system according to a first embodiment of the present invention.

FIG. 2 is a diagram illustrating a functional structure of the communication system depicted in FIG. 1.

FIG. 3 is a diagram illustrating a relationship between a BTS depicted in FIG. 2 and sectors.

FIG. 4 is a diagram illustrating an example of User ID-PRACH PD GAI corresponding information.

FIG. 5 is a diagram for explaining a calculation method of movement information.

FIG. 6 is a diagram for explaining the calculation method of the movement information.

FIG. 7 is a diagram illustrating an example of movement information that a location extractor depicted in FIG. 2 outputs.

FIG. 8 is a diagram for explaining a sector Voronoi diagram.

FIG. 9 is a diagram for explaining a relationship between area units and movement information.

FIG. 10 is a diagram illustrating an example of attribute information that an attribute information storage module depicted in FIG. 2 stores therein.

FIG. 11 is a diagram for illustrating a relationship between the attribute information and the area units.

FIG. 12 is a diagram for explaining a method by which an output module depicted in FIG. 2 calculates total movement information by integrating movement information.

FIG. 13 is a diagram illustrating a display example of the total movement information outputted by the output module depicted in FIG. 2.

FIG. 14 is a diagram illustrating a flow of processes by the communication system depicted in FIG. 2.

FIG. 15 is a diagram illustrating a system structure of a communication system according to a second embodiment of the present invention.

### DESCRIPTION OF EMBODIMENTS

With reference to the attached drawings, embodiments of the present invention will be described. When feasible, same reference signs are given to same parts, and redundant explanations are omitted.

### First Embodiment

[Structure of Communication System]

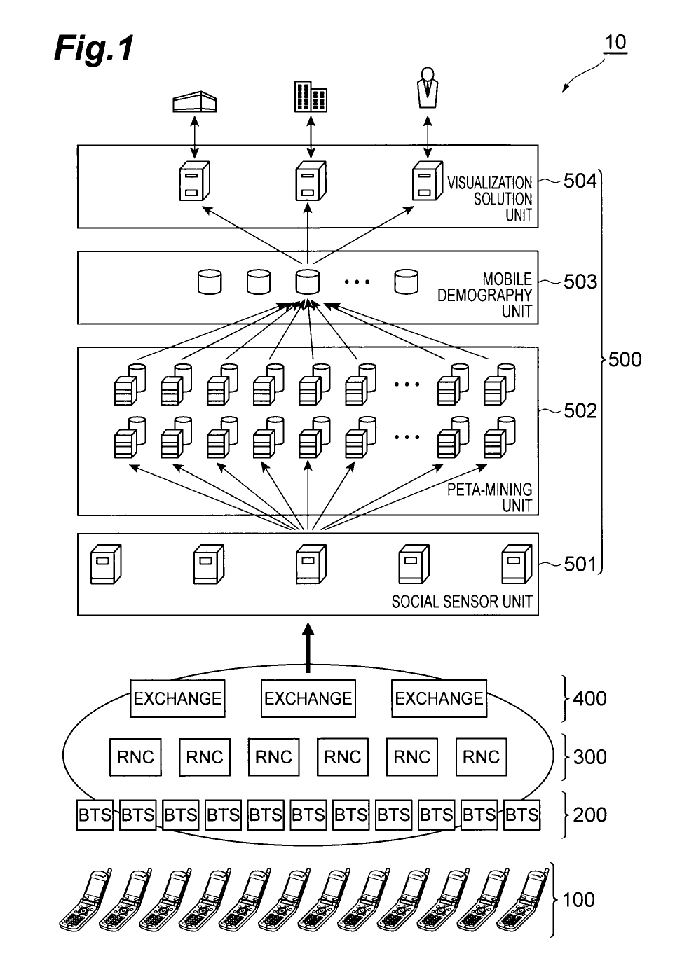

FIG. 1 is a diagram illustrating a system structure of a communication system 10 according to an embodiment of the present invention. As illustrated in FIG. 1, the communication system 10 is configured to include mobile stations 100, base transceiver stations (BTSs) 200, radio network controllers (RNCs) 300, exchanges 400, and a management center 500. The management center 500 is configured to include social sensor units 501, peta-mining units 502, mobile demography units 503, and visualization solution units 504.

The exchange 400 collects location information of the mobile stations 100 via the BTS 200 and the RNC 300. The RNC 300, when communication connection is established with a mobile station 100, can measure a position of the mobile station 100 by using a delay value in an RRC connection request signal. The exchange 400 can receive the location information of the mobile station 100 thus measured when the mobile station 100 establishes communication connection. The exchange 400 stores the location information thus received therein, and outputs the stored location information to the management center 500 at a predetermined timing or in response to a request from the management center 500. In general, there are approximately one thousand RNCs 300 arranged all over Japan. On the other hand, there are approximately three hundred exchanges 400 arranged all over Japan.

The management center 500, as described above, is configured to include the social sensor units 501, the peta-mining units 502, the mobile demography units 503, and the visualization solution units 504 and, in each unit, statistical processes are performed using location information of mobile stations 100.

The social sensor unit 501 is server equipment that collects data including location information of mobile stations 100, from each exchange 400. The social sensor unit 501 is configured to receive data that is outputted periodically from the exchange 400, and to obtain the data from the exchange 400 based on a timing that is predetermined in the social sensor unit 501.

The peta-mining unit 502 is server equipment that converts data received from the social sensor unit 501 into a predetermined data format. For example, the peta-mining unit 502 performs a sorting process by using user IDs as keys or by areas.

The mobile demography unit 503 is server equipment that performs a tallying process for data processed in the peta-mining unit 502, in other words, a counting process for each item. For example, the mobile demography unit 503 can count the number of users located in some area, can tally the number of users to obtain distribution of users, or the like.

The visualization solution unit 504 is server equipment that visualizes data tally-processed in the mobile demography unit 503. For example, the visualization solution unit 504 can perform a mapping of the tallied data onto a map. The data processed in the visualization solution unit 504 is provided to companies, public offices, individuals, or the like, and is used for store development, road traffic research, disaster measures, environmental measures, and the like. However, information thus statistically processed is processed so as not to violate privacy so that individuals or the like cannot be identified.

Each of the social sensor unit 501, the peta-mining unit 502, the mobile demography unit 503, and the visualizing solution unit 504 is configured with server equipment as described above, and their depictions are omitted, but it goes without saying that each of them includes basic components of a conventional information processing apparatus (i.e., a CPU, a RAM, a ROM, input devices such as a keyboard and a mouse, a communication device that communicates with the outside, a storage device that stores information therein, and output devices such as a display and a printer).

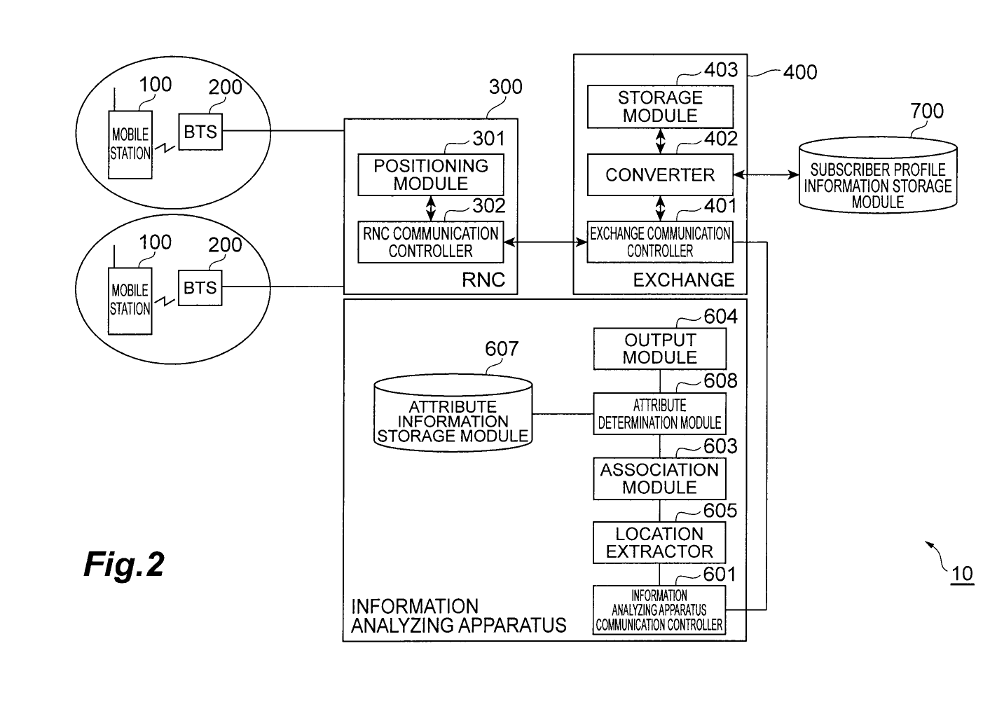

FIG. 2 illustrates a functional structure of the communication system 10. As illustrated in FIG. 2, the communication system 10 is configured to include: a plurality of mobile stations 100 located in sectors controlled by a plurality of BTSs 200; the RNC 300 that controls the BTSs 200; the exchange 400; an information analyzing apparatus 600; and a subscriber profile information storage module 700. The information analyzing apparatus 600 corresponds to the mobile demography unit 503 and the visualization solution unit 504 depicted in the above-described FIG. 1. With respect to functions corresponding to the social sensor unit 501 and the peta-mining unit 502 in FIG. 1, their depictions are omitted in FIG. 2.

The RNC 300 is configured to include a positioning module 301 and an RNC communication controller (transmitter) 302. The exchange 400 is configured to include an exchange communication controller 401, a converter 402, and a storage module 403.

The information analyzing apparatus 600 is configured to include an information analyzing apparatus communication controller (receiver) 601, an association module 603, an output module 604, a location extractor 605, an attribute information storage module 607, and an attribute determination module 608.

The RNC 300 will be described first. The positioning module 301 is a component that, when the later-described RNC communication controller 302 establishes communication connection with a mobile station 100 via the BTS 200, measures a position (coordinates) in a sector in a BTS where the mobile station 100 is located, based on a delay value generated in a process using an RRC connection request signal. The RNC 300 can measure a position in a sector by performing what is called PRACH PD positioning calculation. A sector herein means one of a plurality of areas into which a communication area controlled by a BTS 200 is equally divided. It is acceptable to measure center coordinates of a sector where a mobile station is located as coordinates at which the mobile station 100 lies, without performing the above-mentioned PRACH PD positioning according to communication environment.

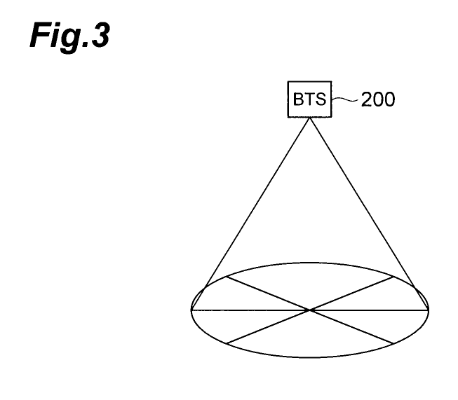

FIG. 3 is a diagram illustrating a relationship between a BTS 200 and sectors. The BTS 200 lies in the center of an area depicted by a circle, and a plurality of pieces into which the area is equally divided by the BTS 200 as a center are sectors. For example, in FIG. 3, a communication area of the BTS 200 consists of at most six sectors, and the RNC 300 can grasp in which sector a mobile station 100 is located via the BTS 200. In the present embodiment, it is also possible to calculate at which location in a sector a mobile station 100 is located and its geographical area ID (GAI) based on a delay of signals obtained when performing a process of RRC connection request. A sector ID is allocated to each sector, making it possible to locate the position of the mobile station 100 based on its sector ID and the location in the sector. When not performing the PRACH PD positioning according to the above-mentioned environment, it is acceptable to use the above-measured center coordinates of the sector where the mobile station 100 is located, as a GAL

The RNC communication controller 302 is a component that establishes communication connection with a mobile station 100 via a BTS 200 and, for example, performs communication connection processing based on a transmission process from the mobile station 100 and communication connection processing based on a location registration request. In the present embodiment, furthermore, the RNC communication controller 302 can add location information of a mobile station 100 to an Initial UE Message used for communication connection processing to transmit the Initial UE Message to the exchange 400. This Initial UE Message includes instruction information indicating transmission or a location registration request, an ID such as a temporary ID for uniquely identifying a mobile station 100, and location information. A temporary ID is ID information delivered by the exchange 400 when a mobile station 100 connects with a network.

The exchange 400 will be described hereinafter. The exchange communication controller 401 is a component that receives an Initial UE Message transmitted from the RNC 300 and performs communication connection processing using this Initial UE Message.

The converter 402 is a component that converts a temporary ID included in the Initial UE Message received by the exchange communication controller 401, into a telephone number. The converter 402, in a converting process, extracts a telephone number related to a temporary ID from a subscriber profile information storage module 700 storing subscriber profile information therein to convert the temporary ID into the telephone number thus extracted. This subscriber profile information storage module is provided to a home location register (HLR), for example, and manages and stores temporary IDs in association with telephone numbers therein.

The storage module 403 is a component that stores therein telephone numbers converted by the converter 402, location information of mobile station 100 included in an Initial UE Message, and the time when the location information is measured, in association with one another. The location information stored in the storage module 403, in accordance with a transmission process performed by the exchange communication controller 401, is collected, at a predetermined timing described later or in response to a request from the management center 500.

The exchange communication controller 401 transmits telephone numbers (i.e. identification information as identifiers that make mobile stations 100 uniquely identifiable) that the storage module 403 stores therein, location information, and time information as times when the location information is measured, to the information analyzing apparatus 600.

The information analyzing apparatus 600 will be described hereinafter. The information analyzing apparatus communication controller 601 is a component that receives the telephone numbers, the location information of mobile stations 100, and the time information when the location information is measured, which the exchange 400 transmits.

The location extractor 605 is a component that inputs the telephone numbers, the location information, and the time information from the information analyzing apparatus communication controller 601, and outputs movement information that is information indicating moving situations of mobile stations 100 at a desired time.

Moving situations of mobile stations 100 at a desired time herein mean movements, for example, from the position measured just before a time set to the position measured just after the time. In the following examples for explanation, as a moving situation of a mobile station 100 at a desired time, explanation is made by using a movement from the location where the position was measured just before a time set to the location where the position was measured just after the time, but it is not intended to be limited to this. For example, it is acceptable to use a plurality of pieces of location information (moving models) measured just before the desired time to estimate the moving situation (the current moving models) at the desired time. In this case for example, it is acceptable to extend a straight line connecting two preceding measurement locations to estimate the moving situation at the desired time by proportional time division. Of course, it is acceptable to use two or more measurement locations.

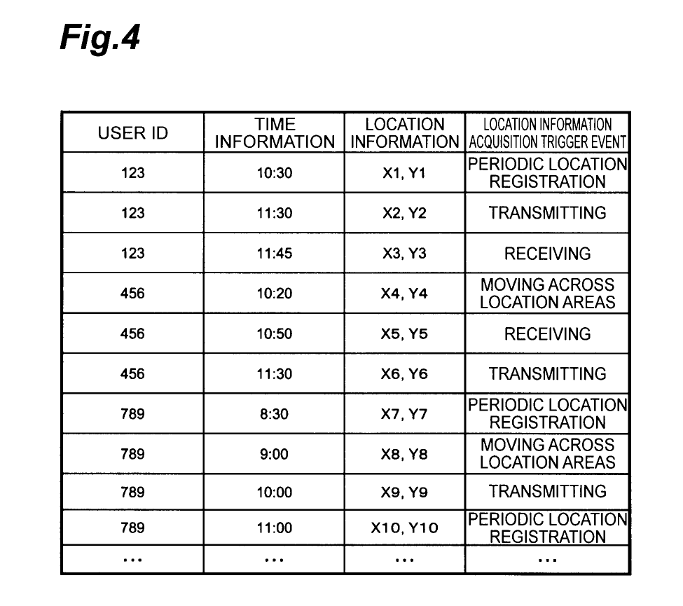

Referring now to FIGS. 4 to 7, an extracting method of the position of a mobile station 100 just before a desired time will be described.

FIG. 4 illustrates an example of information that the location extractor 605 uses. As illustrated in this drawing, the information that the location extractor 605 uses is information in which time information, location information and a location information acquisition trigger event are related to a user ID (hereinafter, this information may be referred to as “User ID-PRACH PD GAI corresponding information”).

With respect to a “User ID”, the information analyzing apparatus 600, by referring to storing means (not depicted) in which user IDs associated with telephone numbers are stored, obtains a user ID that is associated with a telephone number input from the information analyzing apparatus communication controller 601.

Stored in the “time information” is a time when location information is measured. Stored in the “location information” is position information of a mobile station 100 that is measured by performing what is called PRACH PD positioning calculation according to the above-mentioned method, or information regarding center coordinates of a sector in which a mobile station 100 is located. It is acceptable to express the location information in latitude and longitude. Alternatively, it is acceptable to set a reference point to indicate it in relative position from the reference point.

Stored in the “location information acquisition trigger event” is a type of a trigger event due to which location information of a mobile station 100 is measured. The trigger event is preferably at least one of (1) periodically (for example, approximately a one-hour period), (2) when transmitting and receiving, and (3) when the mobile station 100 moves across a boundary of location registration areas. However, the trigger event for measuring a position is not limited to these, and it is possible to set a desired trigger event.

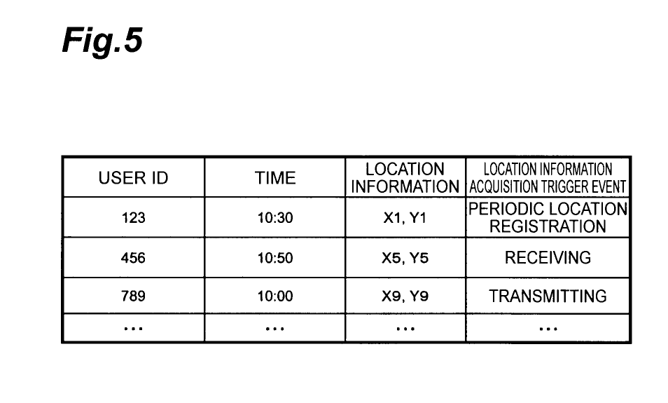

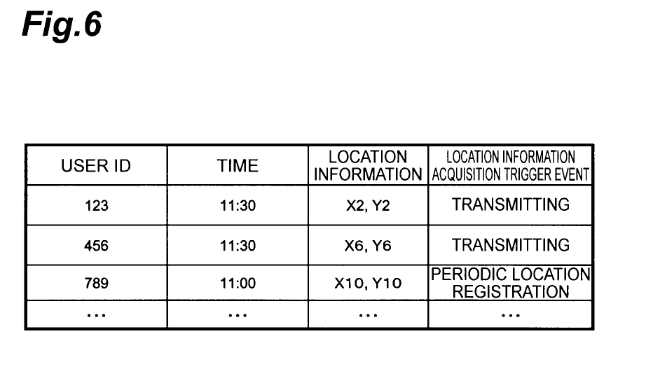

Assume here a case of desiring to obtain a population flow rate at 11 o'clock. In this case, the location extractor 605 selects information in which the “time” is just before and just after 11:00 out of the information indicated in FIG. 4 by user IDs. Examples of the information selected are illustrated in FIG. 5 and FIG. 6. FIG. 5 indicates information just before the desired time, and FIG. 6 indicates information just after the desired time. For example, for a mobile station 100 that a user whose user ID is “123” has, its position was measured at 10:30, 11:30, and 11:45. In this case, information measured at 10:30 just before the desired time (11:00 in this example) and information measured at 11:30 just after the desired time are selected.

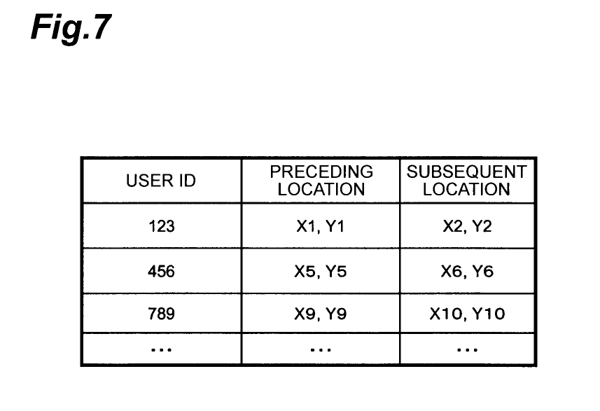

FIG. 7 illustrates an example of movement information that the location extractor 605 outputs. As illustrated in FIG. 7, the location extractor 605, for the user whose user ID is “123”, for example, outputs as movement information the location (X1,Y1) (i.e., the location where the position was measured just before), the location (X2,Y2) (i.e., the location where the position was measured just after), and the user ID.

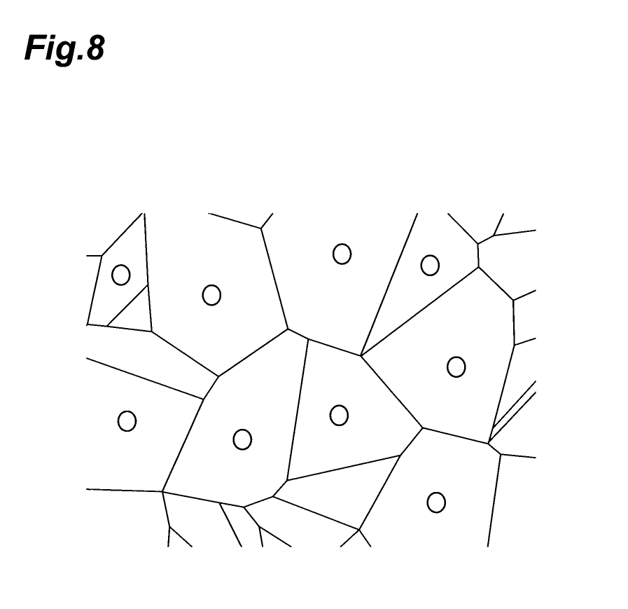

Referring back to FIG. 2, the association module 603 is a component that converts the location information that the location extractor 605 extracts into an expression form for giving expression as a movement from one area unit to another area unit in association with a desired area unit having a certain range of spread. The desired area unit may be in a mesh pattern. Alternatively, it is acceptable to set an administrative district such as a municipality as the area unit. Or, it is acceptable to use a Voronoi diagram exemplarily illustrated in FIG. 8. In FIG. 8, positions indicated by open circles represent center latitudes/longitudes of sectors. As illustrated in this drawing, a Voronoi diagram is a diagram in which sectors are divided by bisectors between center latitudes/longitudes of adjacent sectors one another. Furthermore, if there is corresponding information of sectors and locations, for example, a map of power distribution for each sector (a service area map) is available, it is acceptable to use this.

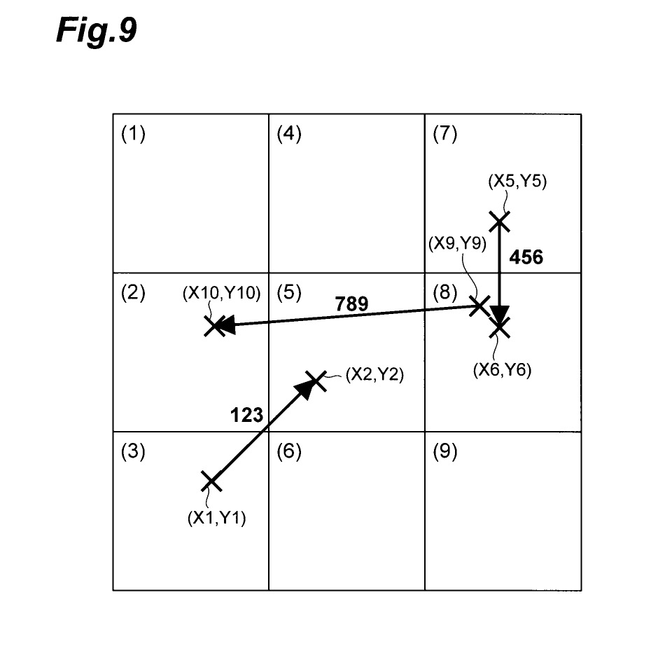

FIG. 9 is a diagram for explaining a method of converting the location information into an expression form for giving expression as a movement from one area unit to another area unit in association with a desired area unit. The desired area unit is in a square grid herein. In FIG. 9, an area unit identifier that makes each square uniquely identifiable is written in parentheses on the upper left of each square. When the position of a mobile station 100 is located (in the present description, represented as (X1,Y1), etc.), one corresponding area unit is identified. In this example, in an example of the user whose user ID is “123” (the movement information is (X1,Y1)→(X2,Y2)) for example, the user moved from an area unit whose area unit identifier is (3) to an area unit whose area unit identifier is (5).

By this method, the association module 603 can convert the location information that the location extractor 605 extracts into an expression form for giving expression as the movement from one area unit (whose area unit identifier is (3)) to another area unit (whose area unit identifier is (5)) in association with an area unit having a certain range of spread.

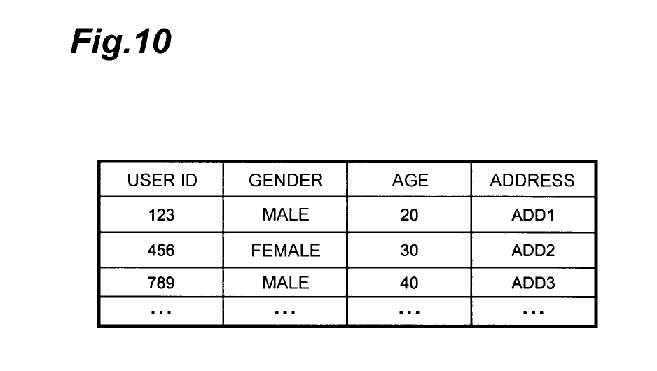

Referring back to FIG. 2, the attribute information storage module 607 is a component that stores therein attribute information of users of mobile stations 100 in association with user IDs. FIG. 10 illustrates an example of attribute information that the attribute information storage module 607. As illustrated in FIG. 10, attribute information may include genders, ages, and addresses.

The attribute determination module 608 is a component that determines, based on attribute information that the attribute information storage module 607 stores therein, whether or not to use movement information for outputting total movement information (that is obtained by integrating movement information) described later.

More specifically, the attribute determination module 608 determines whether or not a desired attribute satisfies a certain requirement by referring to the attribute information that the attribute information storage module 607 stores therein. When determining that it satisfies the certain requirement, the attribute determination module 608 determines to use the corresponding movement information to output the total movement information described later. When determining that it does not satisfy the certain requirement, the attribute determination module 608 determines not to use the corresponding movement information to output the total movement information described later.

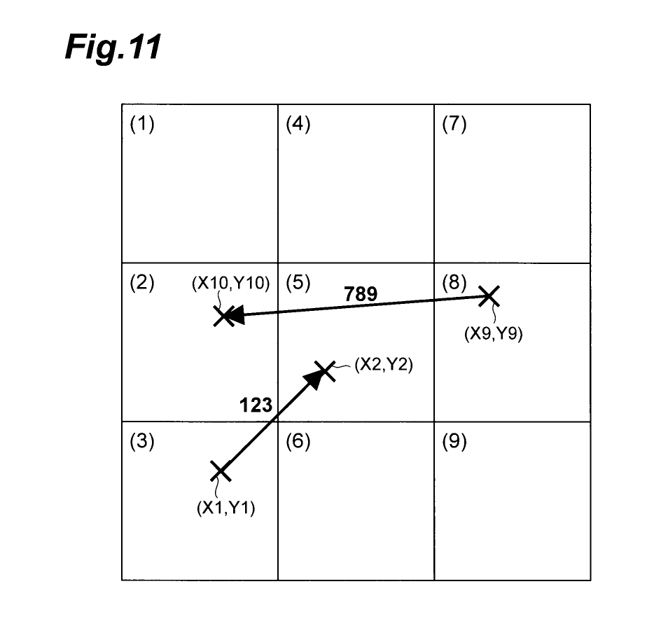

FIG. 11 illustrates an example of the case of using movement information in which an attribute “gender” (a desired attribute) is “male” (i.e. satisfying a certain requirement). It is possible to set the desired attribute and the certain requirement freely.

Alternatively, for example, it is acceptable to set the attribute as “age” and to set the certain requirement as “equal to or more than 10 years old and less than 30 years old”. Or, it is acceptable to set the attribute as “address” and set the certain requirement as “Chuo-ward”.

The output module 604 is a component that calculates total movement information by integrating the movement information that is determined to be used so as to be outputted by the attribute determination module 608, and outputs the total movement information thus calculated.

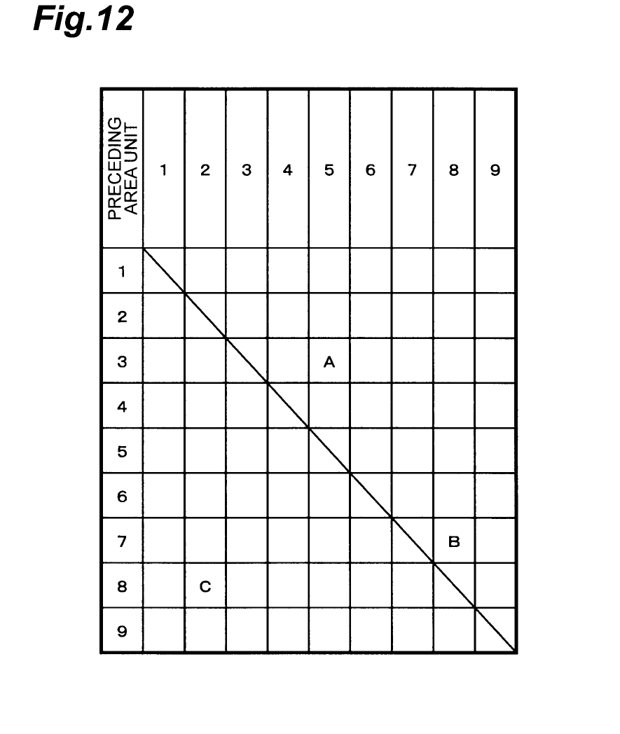

FIG. 12 is a diagram for explaining the method of calculating the total movement information by integrating the movement information. Note that, in FIG. 12, numerals that should be written in the table are omitted. In the leftmost column in FIG. 12, identifiers of area units corresponding to location information that is measured just before the desired time are written. In the top row in FIG. 12, identifiers of area units corresponding to location information that is measured just after the desired time are written.

With examples illustrated in FIG. 7 and FIG. 9, explanation will be given. The user whose user ID is “123” moved from the area unit identifier (3) to (5), and accordingly one is added to the number in the cell indicated by A in FIG. 12. Similarly, a user whose user ID is “456” moved from the area unit identifier (7) to (8), and accordingly one is added to the number in the cell indicated by B in FIG. 12. A user whose user ID is “789” moved from the area unit identifier (8) to (2), and accordingly one is added to the number in the cell indicated by C in FIG. 12.

By the above-mentioned method, it is possible to integrate movement information and thus calculate total movement information (i.e., information into which movement information regarding a plurality of mobile stations 100 is compiled for each area unit).

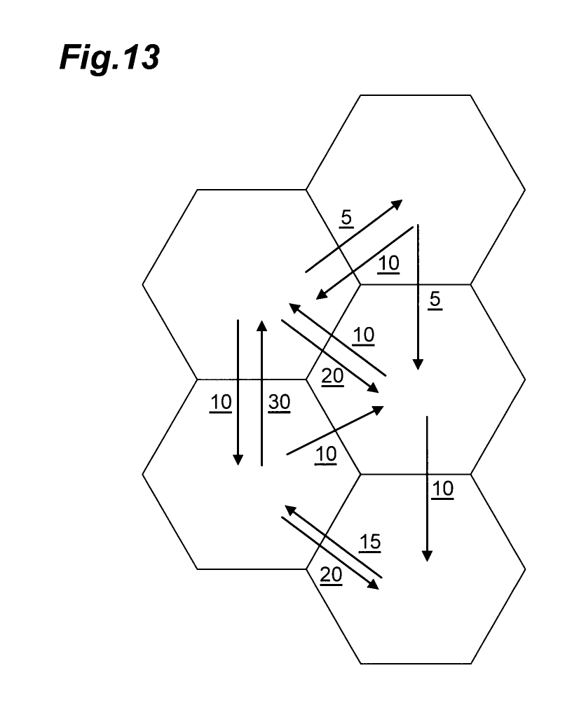

FIG. 13 illustrates a display example of the total movement information calculated by the above-mentioned method. In this drawing, each of the areas surrounded by hexagons indicates one area unit. This display example indicates that people moved from area units lying at the start points of the arrows to area units lying at the tips of the arrows in the ratio of the numbers written near the arrows.

It should be noted that FIG. 13 displays only the number of population flow between adjacent cells, but the present invention is characterized in that it is possible to display the number of population flow between nonadjacent cells as indicated by the arrow from the area unit identifier (8) to (2) in FIG. 9, for example. Furthermore, as an additional function, the given time regarding the above-mentioned movement information may have a time range, and the time range may be optionally settable. In this case, the location extractor 605, with respect to the movement information at the given time having the time range, extracts movement information for each of a plurality of time zones obtained by dividing the time range in plurality (for example, dividing in plurality by hours). The output module 604 then integrates the movement information for each of a plurality of time zones to calculate total movement information (the number of population flow) for each time zone, and integrates the total movement information for each time zone (i.e., sums up the number of population flow for each time zone) to calculate total movement information (the number of population flow) at the given time having the time range. Accordingly, the output module 604 can output the total movement information (the number of population flow) at the given time having the time range. In this manner, because it is possible to obtain the total movement information (the number of population flow) at the given time having the time range, it is possible to display the number of population flow between nonadjacent cells as described above.

Display of population flow is not limited to this example. Various methods other than this can be thought of. For example, it is acceptable to vary the thickness of arrows depending on the volume of population flow. In addition, it is acceptable to vary the color types of the arrows, or acceptable to vary the depth of the colors of the arrows depending on the number of the population flow. Alternatively, arrow display is not indispensable and it is possible to output the difference in volume of the population flow in different colors by sectors.

It goes without saying that the term “output” herein widely includes display output and print output. In other words, population fluidity information may be displayed on a display or the like, may be printed out from a printer or the like, or may be output both in display and in print.

It should be noted that, by referring to the “location information acquisition trigger event” indicated in FIG. 5 and FIG. 6, it is acceptable to display only information whose location information is obtained due to a specified signal type (certain signal type). In this case, it is acceptable to display only information whose “location information acquisition trigger event” is “periodical location registration”, for example. If it is known that there is bias in information whose “location information acquisition trigger event” is “transmitting”, for example, it is possible to exclude bias arising from such a certain signal type.

[Flow of Process Performed in Communication System]

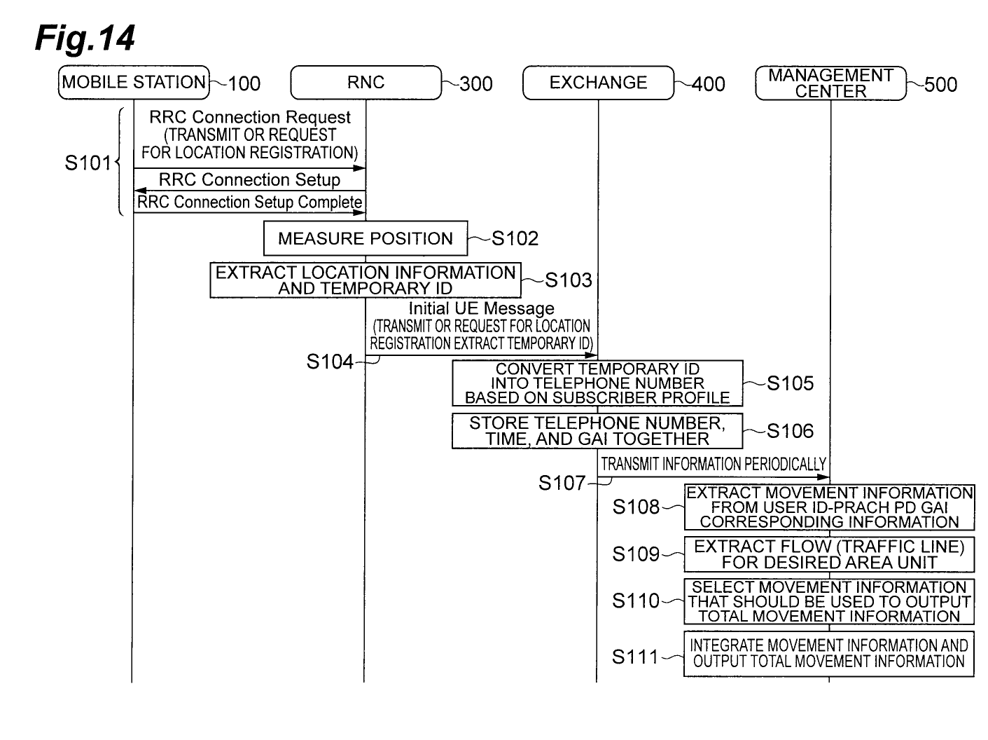

Processes of the communication system 10 thus structured will be described hereinafter referring to FIG. 14.

When a transmission request or a location registration request is outputted from a mobile station 100, in the RNC 300, in accordance with these requests, the position measurement of the mobile station 100 is performed (step S101). In other words, when an RRC connection request is received by the RNC 300 (the RNC communication controller 302), by the RNC communication controller 302, an RRC connection setup is transmitted to the mobile station 100. A completion signal of the RRC connection setup from the mobile station 100 is received by the RNC communication controller 302 (step S101). Based on a delay value of the signal obtained herein, approximate location information in a sector of the mobile station 100 is calculated by the positioning module 301, and position measurement is performed (step S102: positioning step).

In the RNC 300, by the RNC communication controller 302, location information of the mobile station 100 and its temporary ID are extracted (step S103). By the RNC communication controller 302, the location information and the temporary ID extracted are added to an Initial UE Message and sent to the exchange 400 (step S104: transmitting step).

In the exchange 400, by the exchange communication controller 401, an Initial UE Message is received, and the temporary ID included in the Initial UE Message is converted into a telephone number of the mobile station 100 by the converter 402 (step S105). In the storage module 403, the telephone number thus converted, time information as the time when the position is measured, and the location information are stored in association with one another (step S106).

The telephone number, the time information, and the location information stored in the storage module 403 are periodically transmitted by the management center 500, or are obtained in accordance with a request from the management center 500 (step S107).

More specifically, the management center, using as a trigger event at least any one of (1) periodically (for example, approximately a one-hour period), (2) when transmitting and receiving, and (3) when the mobile station 100 moves across a boundary of location registration areas, obtains the location information.

The management center 500, based on the User ID-PRACH PD GAI corresponding information, by users, extracts movement information that is information indicating a moving situation of the mobile station 100 just before and just after a desired time (step S108: location extracting step).

The management center 500 converts the movement information extracted at step S108 into an expression form for giving expression as a movement from one area unit to another area unit in association with a desired area unit (step S109).

The management center 500 determines whether or not to use the movement information to output total movement information based on attribute information, and selects only movement information that should be used (step S110).

The management center 500 outputs total movement information as information into which the movement information is integrated for companies, public offices, or individuals, for example (step S111: outputting step).

[Operation and Effect]

An operation and an effect of the communication system 10 of the present embodiment will be described hereinafter.

With the communication system 10 of the present embodiment, by easily and quickly collecting information regarding location information of mobile stations 100 and information regarding times when their positions were measured and outputting total movement information into which movement information of the mobile stations 100 are integrated based on these information, it is possible to easily and quickly obtain survey results data regarding macroscopic population fluidity.

The positioning module 301 of the RNC 300 measures a position of the mobile station 100, by using at least any one of the followings as a triggering event: when the mobile station 100 transmits; when the mobile station 100 receives a communication; and when the mobile station 100 moves across a boundary of location registration areas which are areas formed by the BTS 200 and are unit areas in which the mobile station 100 registers its own position with the RNC 300. Accordingly, it is possible to perform position measurement while suppressing additional load to various types of communication equipment.

The positioning module 301 of the RNC 300 measures a position of a mobile station when a given timing in a given period arrives. Accordingly, it is possible to measure a position at least once in the given period without exception.

In addition, the information analyzing apparatus 600 further includes the association module 603 that converts the expression form of movement information extracted by the location extractor 605 into an expression form for giving expression as a movement from one area unit to another area unit in association with an area unit having a certain range of spread. Accordingly, it is possible to output total movement information with accuracy responding to requests by setting the area unit to a desired unit (for example, an area 100 meters square, an area 10 kilometers square, or an administrative district such as a municipality).

In addition, the information analyzing apparatus 600 further includes the attribute information storage module 607 that stores attribute information representing attributes of a user using the communication system 10 in association with identification information therein, and the attribute determination module 608 that determines whether or not to use the movement information so as to integrate the movement information and output the total movement information thus integrated, based on the attribute information stored by the attribute information storage module 607. Accordingly, it is possible to output total movement information by desired attributes.

### Second Embodiment

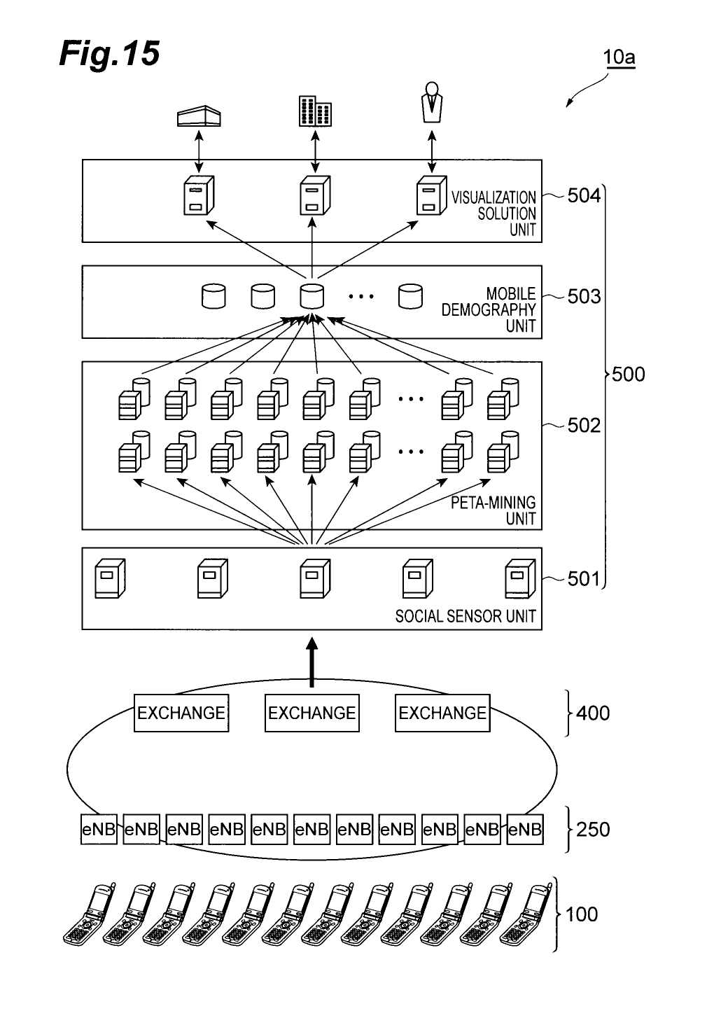

FIG. 15 is a system structure diagram of a communication system 10a according to a second embodiment of the present invention. As illustrated in FIG. 15, this communication system 10a has a system structure for the case of applying it to Long Term Evolution (LTE) that is a new communication standard, and is configured to include mobile stations 100, Evolution Node Bs (eNBs) 250, exchanges 400, and a management center 500. The management center 500 is configured with social sensor units 501, peta-mining units 502, mobile demography units 503, and visualization solution units 504. The eNB 250 includes both functions of the BTS 200 and the RNC 300.

The second embodiment is a system structure for the case of applying it to LIE and the contents of its specific processes are the same as those of the above-mentioned first embodiment, and accordingly its specific description is omitted. In the first embodiment, its protocol is Radio Access Network Application Part (RANAP). In the second embodiment, S1 Application Protocol (S1AP) used for LTE is used and, with respect to the Initial UE Message, the same signals are used for S1AP.

In the first embodiment and the second embodiment, descriptions are made assuming the third-generation cellular phone (3G) system, but these are applicable to Global System for Mobile Communications (GSM).

### INDUSTRIAL APPLICABILITY

According to the present invention, it is possible to easily and quickly (in almost real time) collect data regarding macroscopic population fluidity and obtain survey results.

### REFERENCE SIGNS LIST

10, 10a . . . communication system, 100 . . . mobile station, 200 . . . BTS, 250 . . . eNB, 300 . . . RNC, 301 . . . positioning module, 302 . . . RNC communication controller, 400 . . . exchange, 401 . . . exchange communication controller, 402 . . . converter, 403 . . . storage module, 500 . . . management center, 501 . . . social sensor unit, 502 . . . peta-mining unit, 503 . . . mobile demography unit, 504 . . . visualization solution unit, 600 . . . information analyzing apparatus, 601 . . . information analyzing apparatus communication controller, 603 . . . association module, 604 . . . output module, 605 . . . location extractor, 607 . . . attribute information storage module, 608 . . . attribute determination module, 700 . . . subscriber profile information storage module

1. A communication system configured to comprise:
a mobile station that is located in a sector that a base transceiver station controls;
a radio network controller that controls the base transceiver station; and
an information analyzing apparatus that is communicably connected with the radio network controller,
wherein the radio network controller comprises:
a positioning module that measures a position of the mobile station; and
a transmitter that transmits location information as information regarding the position of the mobile station that the positioning module measures, identification information as an identifier that makes the mobile station uniquely identifiable, time information as information regarding a time when the positioning module measures the position of the mobile station, and information on a location information acquisition trigger event for the positioning module to measure the position of the mobile station, to the information analyzing apparatus,
wherein the information analyzing apparatus comprises:
a location extractor that extracts movement information indicating a moving situation of the mobile station at a given time and including information corresponding to at least the location information, based on the location information, the identification information and the time information; and
an output module that calculates total movement information by integrating the movement information and outputs the total movement information thus calculated, based on the information on the location information acquisition trigger event.

2. The communication system according to claim 1,
wherein the positioning module measures the position of the mobile station using, as a trigger event, at least any one of
when the mobile station transmits,
when the mobile station receives a transmission,
when the mobile station moves across a boundary of location registration areas which are areas formed by the base transceiver station and are unit areas in which the mobile station registers a position thereof with the radio network controller, and
when a given timing in a given period arrives.

3. The communication system according to claim 1,
wherein the information analyzing apparatus further comprises an association module that converts an expression form of the movement information extracted by the location extractor into an expression form for giving expression as a movement from one area unit to another area unit in association with an area unit having a certain range of spread.

4. The communication system according to claim 1,
wherein the information analyzing apparatus further comprises:
an attribute information storage module that stores attribute information representing attributes of a user using the communication system in association with the identification information therein; and
an attribute determination module that determines whether or not to use the movement information so as to integrate the movement information and output the total movement information thus integrated, based on the attribute information stored by the attribute information storage module.

5. The communication system according to claim 1,
wherein the given time has a time range, and the time range is optionally settable.

6. The communication system according to claim 5,
wherein the location extractor, with respect to the movement information at the given time having the time range, extracts movement information for each of a plurality of time zones that are obtained by dividing the time range in plurality, and
the output module integrates the movement information for each of the plurality of time zones to calculate total movement information for each time zone, and integrates the total movement information for each time zone to calculate total movement information at the given time having the time range.

7. The communication system according to claim 6,
wherein the output module outputs the total movement information at the given time having the time range.

8. An information analyzing apparatus communicably connected with a radio network controller that controls a base transceiver station controlling a sector in which a mobile station is located, the information analyzing apparatus comprising:
a receiver that receives location information as information regarding a position of the mobile station that the radio network controller measures, identification information as an identifier that makes the mobile station uniquely identifiable, time information as information regarding a time when the radio network controller measures the position of the mobile station, and information on a location information acquisition trigger event for the radio network controller to measure the position of the mobile station;
a location extractor that extracts movement information indicating a moving situation of the mobile station at a given time and including information at least corresponding to the location information based on the location information, the identification information and the time information that the receiver receives; and
an output module that calculates total movement information by integrating the movement information and outputs the total movement information thus calculated, based on the information on the location information acquisition trigger event.

9. An information analyzing method executed in a communication system constituted to comprise: a mobile station that is located in a sector that a base transceiver station controls; a radio network controller that controls the base transceiver station; and an information analyzing apparatus that is communicably connected with the radio network controller, the information analyzing method comprising:
a positioning step in which the radio network controller measures a position of the mobile station;
a transmitting step in which the radio network controller transmits location information as information regarding the position of the mobile station that is measured at the positioning step, identification information as an identifier that makes the mobile station uniquely identifiable, time information as information regarding a time when the position of the mobile station is measured at the positioning step, and information on a location information acquisition trigger event to measure the position of the mobile station in the positioning step, to the information analyzing apparatus;
a location extracting step in which the information analyzing apparatus extracts movement information indicating a moving situation of the mobile station at a given time and including information at least corresponding to the location information based on the location information, the identification information and the time information; and
an outputting step in which the information analyzing apparatus calculates total movement information by integrating the movement information and outputs the total movement information thus calculated, based on the information on the location information acquisition trigger event.
